(19) United States
(12) Patent Application Publication
(10) Pub. No.: US 2025/0378322 A1
(43) Pub. Date: Dec. 11, 2025

(54) CONTEXT RECOMMENDATION FOR RETRIEVAL AUGMENTED GENERATION ARCHITECTURES

(71) Applicant: Dell Products L.P., Round Rock, TX (US)

(72) Inventors: Thiagarajan Ramakrishnan, Round Rock, TX (US); Bijan Kumar Mohanty, Austin, TX (US); Shamik Kacker, Austin, TX (US); Hung Dinh, Austin, TX (US)

(21) Appl. No.: 18/738,673

(22) Filed: Jun. 10, 2024

(51) Int. Cl. G06N 3/08; G06N 3/045

(52) U.S. Cl. CPC G06N 3/08; G06N 3/045

(57) ABSTRACT

A method comprises receiving a large language model request, analyzing the large language model request using one or more machine learning algorithms, and predicting, based at least in part on the analyzing: (i) a large language model of a plurality of large language models to process and to respond to the large language model request; and (ii) at least one database from which data is to be used to generate a prompt for the large language model. The method further comprises interfacing with the large language model and the at least one database to enable the large language model to process and to respond to the large language model request.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to context recommendation in information processing systems.

### BACKGROUND

The growth of large language models (LLMs) has been a notable trend in the field of artificial intelligence and natural language processing, leading to advancements in textual understanding and language generation. However, at times, LLMs may generate factually unsupported content in response to a query or generate content which is not responsive to a query. Efforts have been made to address these issues, but when faced with a large number of LLMs, such efforts are not effective.

### SUMMARY

Embodiments provide a context recommendation platform in an information processing system.

For example, in one embodiment, a method comprises receiving a large language model request, analyzing the large language model request using one or more machine learning algorithms, and predicting, based at least in part on the analyzing: (i) a large language model of a plurality of large language models to process and to respond to the large language model request; and (ii) at least one database from which data is to be used to generate a prompt for the large language model. The method further comprises interfacing with the large language model and the at least one database to enable the large language model to process and to respond to the large language model request.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system with a context recommendation platform according to an illustrative embodiment.

FIG. 2 depicts a plurality of retrieval augmented generation (RAG) architectures according to an illustrative embodiment.

FIG. 3 depicts an operational flow for vector store and LLM prediction according to an illustrative embodiment.

FIG. 4A depicts example pseudocode for generating a vector of a request sentence according to an illustrative embodiment.

FIG. 4B depicts a vector of a request sentence according to an illustrative embodiment.

FIG. 5 depicts example pseudocode for generating a hash from a request vector according to an illustrative embodiment.

FIG. 6 depicts sample training data for training a machine learning algorithm for vector store and LLM prediction according to an illustrative embodiment.

FIG. 7A depicts example pseudocode for common embedding of a request and principal component analysis (PCA) to reduce dimensionality of a request vector according to an illustrative embodiment.

FIG. 7B depicts the request vector with reduced dimensionality according to an illustrative embodiment.

FIG. 8 depicts example pseudocode for importation of libraries and for loading historical request response data into a data frame according to an illustrative embodiment.

FIG. 9 depicts example pseudocode for encoding a dataset for machine learning according to an illustrative embodiment.

FIG. 10 depicts example pseudocode for splitting a dataset into training and testing components and for creating separate datasets for independent and dependent variables according to an illustrative embodiment.

FIG. 11 depicts example pseudocode for using designated model functions to build a neural network according to an illustrative embodiment.

FIG. 12 depicts example pseudocode for assembling a neural network, setting a loss function, metrics and an optimizer of a neural network, and training the model according to an illustrative embodiment.

FIG. 13 depicts a process for context recommendation according to an illustrative embodiment.

FIGS. 14 and 15 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a developer device receives messages without any significant time delay. Of course, it should be understood that depending on the particular temporal nature of the system in which an embodiment is implemented, other appropriate timescales that provide at least contemporaneous performance and output can be achieved.

As used herein, “application programming interface (API)” refers to a set of subroutine definitions, protocols, and/or tools for building software. Generally, an API defines communication between software components. APIs permit software applications to be written so as to be consistent with an operating environment or website. In a non-limiting example, APIs enable software components to communicate with each other using designated definitions and protocols.

As used herein, “natural language” is to be broadly construed to refer to any language that has evolved naturally in humans. Non-limiting examples of natural languages include, for example, English, Spanish, French and Hindi.

As used herein, “natural language processing (NLP)” is to be broadly construed to refer to interactions between computers and human (natural) languages, where computers are able to derive meaning from human or natural language input, and respond to requests and/or commands provided by a human using natural language.

As used herein, “natural language understanding (NLU)” is to be broadly construed to refer to a sub-category of natural language processing in artificial intelligence where natural language input is disassembled and parsed to determine appropriate syntactic and semantic schemes in order to comprehend and use languages. NLU may rely on computational models that draw from linguistics to understand how language works, and comprehend what is being said by a user.

As used herein, “natural language generation (NLG)” is to be broadly construed to refer to a computer process that transforms data into natural language. For example, NLG systems decide how to put concepts into words. NLG can be accomplished by training machine learning models using a corpus of human-written texts.

As used herein, a “large language model (LLM)” refers to a trained neural network capable of using NLG techniques to generate coherent and relevant human-like text (e.g., natural language) from a given prompt. In illustrative embodiments, an LLM is trained and re-trained (e.g., through a feedback loop based on the accuracy of the output) on massive amounts of data to learn to identify patterns and relationships within text, allowing it to generate high-quality output. With their ability to understand and produce human-like language, LLMs of the illustrative embodiments are used in NLP applications. In the context of NLP, the input prompt comprises text that serves as an input for the LLM to generate a corresponding output. The prompt comprises one or more instructions given to the model that guides it in producing a relevant and coherent response.

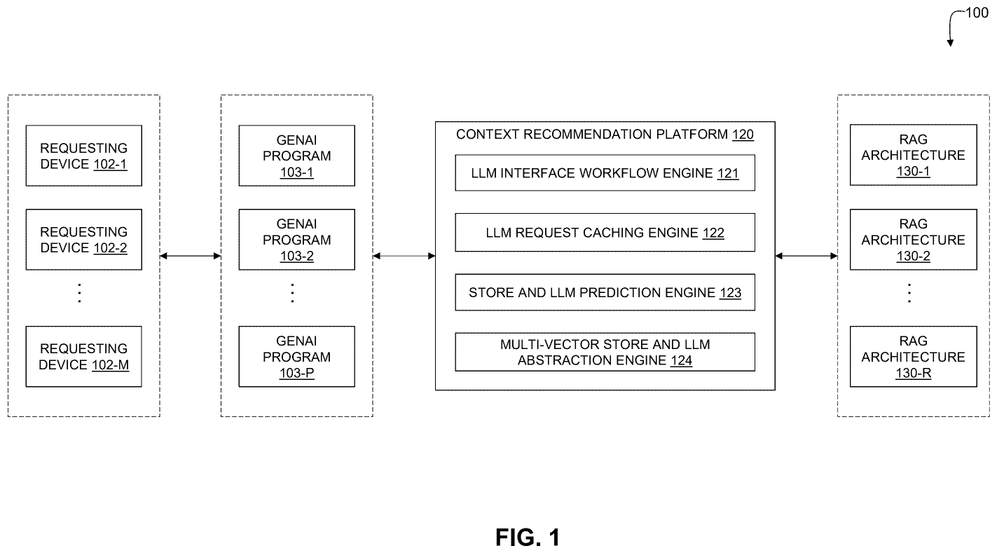

FIG. 1 shows an information processing system 100 configured in accordance with an illustrative embodiment. The information processing system 100 comprises requesting devices 102-1, 102-2, . . . 102-M (collectively “requesting devices 102”), a plurality of generative AI (GenAI) programs 103-1, 103-2, . . . , 103-P (collectively “GenAI programs 103”), a context recommendation platform 120 and a plurality of retrieval augmented generation (RAG) architectures 130-1, 130-2, . . . , 130-R (collectively “RAG architectures 130”). The requesting devices 102, GenAI programs 103, context recommendation platform 120 and RAG architectures 130 communicate with each other over a network as shown by the arrows connecting the requesting devices 102, GenAI programs 103, context recommendation platform 120 and RAG architectures 130. The variable M and other similar index variables herein such as K, L, N, P and R are assumed to be arbitrary positive integers greater than or equal to one.

The requesting devices 102, one or more devices on which the GenAI programs 103 are run and one or more devices on which the RAG architectures 130 are run can comprise, for example, Internet of Things (IoT) devices, server, desktop, laptop or tablet computers, mobile telephones, or other types of processing devices capable of communicating with the context recommendation platform 120 over the network. Such devices are examples of what are more generally referred to herein as “processing devices.” Some of these processing devices are also generally referred to herein as “computers.” The requesting devices 102, one or more devices on which the GenAI programs 103 are run and one or more devices on which the RAG architectures 130 are run may also or alternately comprise virtualized computing resources, such as virtual machines (VMs), containers, etc. The requesting devices 102, one or more devices on which the GenAI programs 103 are run and/or one or more devices on which the RAG architectures 130 are run in some embodiments comprise respective computers associated with a particular company, organization or other enterprise.

The terms “requester,” “administrator,” “personnel” or “user” herein are intended to be broadly construed so as to encompass numerous arrangements of human, hardware, software or firmware entities, as well as combinations of such entities. Context recommendation services may be provided for users utilizing one or more machine learning models, although it is to be appreciated that other types of infrastructure arrangements could be used. At least a portion of the available services and functionalities provided by the context recommendation platform 120 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the context recommendation platform 120, as well as to support communication between the context recommendation platform 120 and connected devices (e.g., requesting devices 102, one or more devices on which the GenAI programs 103 are run and/or one or more devices on which the RAG architectures 130 are run) and/or other related systems and devices not explicitly shown.

In some embodiments, the requesting devices 102 are assumed to be associated with repair technicians, system administrators, information technology (IT) managers, software developers, release management personnel or other authorized personnel configured to access and utilize the context recommendation platform 120. The requesting devices 102 can also be respectively associated with one or more users requiring the services of the context recommendation platform 120.

As noted herein above, at times, LLMs may generate factually unsupported content in response to a query or generate content which is not responsive to a query. These issues have been referred to as factuality and faithfulness hallucinations, respectively. LLMs may be trained on voluminous amounts of data (e.g., billions of tokens) to provide the LLMs with extensive knowledge and powerful reasoning capabilities. However, in some situations, the LLMs are not fine-tuned with specialized data to enhance the model's knowledge. Such fine-tuning may be relevant to specific use-cases of respective LLMs. In order to make up for the lack of fine-tuning, retrieval augmented generation (RAG) architectures are leveraged. In the case of, for example, an enterprise, in an effort to produce accurate outputs that are responsive to given queries, the RAG architecture leverages data from enterprise data sources to add context to LLM prompts. The RAG architectures (e.g., RAG architectures 130) retrieve and inject external information to augment an LLM prompt so that models can generate outputs with specific context from unique data sources.

RAG implementations can include, for example, pre-processing, retrieval and reasoning components. Pre-processing takes raw data to be used by LLMs and transforms the data into a format which can be used during inference. Such transformation can include adding data connectors, chunk processing, metadata extraction, embedding generation and storing embeddings in a vector store relevant to a given context. Retrieval includes searching vector stores for embeddings, ranking results based on relevance and responding to users. With current approaches, a selection process of a knowledge base from which data can be leveraged to add context to LLM prompts is a complex and costly process, involving many data scientists, data engineers and enterprise stakeholders to manually analyze enterprise requirements and training data. This process is often repeated by different teams in different divisions, causing the quality of knowledge base selection to vary from team to team. Moreover, as is often the case, large enterprises may utilize multiple RAG implementations across various domains. Respective RAG implementations may use different techniques for embedding, vector store creation and vector selection. For example, respective RAG implementations may leverage different context vector store product technologies (e.g., pgVector, Faais, PineCone, ChromaDB, etc.), and the data quality in each store may vary between various domains and/or initiatives. This lack of consistency can cause multiple issues with retrieving and implementing the right context for received requests for LLM outputs. For example, this federated approach might result in a lack of visibility of potentially better context in other stores for a given query.

In large enterprises where multiple (e.g., hundreds) of GenAI programs (e.g., GenAI programs 103) are being implemented, clear issues are present in creating and managing multiple context stores, in synthesizing context data for each store and retrieving the appropriate context data for each LLM request. For example, large enterprises may use many context stores implementing various vector database technologies. Moreover, as data in any enterprise is not always clearly segregated across domains, data from one domain is often relevant to another domain and a store from one domain potentially can return more appropriate context for a given query than a store from the other domain.

In order to address the problems with current approaches, illustrative embodiments provide technical solutions that utilize a sophisticated, multi-prong approach to select a context store and use automated and/or manual feedback regarding the quality of LLM responses to continuously upgrade and/or fine-tune the efficiency of context store selection. The intelligent context store selection capability is achieved by leveraging a deep neural network-based classification algorithm, which is trained with historical request and store selection data along with quality values of the selected vector stores and LLMs (e.g., efficiency scores). The embodiments advantageously utilize a context recommendation platform 120 implementing a machine learning component that can predict the right context store for a query based on, for example, proven efficiency of using the context store for similar queries. As context stores and data evolve over time, the embodiments dynamically update the quality values of the stores. As explained herein, the dynamic updates can be performed with user intervention and/or with automated mechanisms to monitor LLM responses and update quality values of context stores used in connection with generating the corresponding prompts that solicited the responses.

The context recommendation platform 120 in the present embodiment is assumed to be accessible to the requesting devices 102, one or more devices on which the GenAI programs 103 are run and/or one or more devices on which the RAG architectures 130 are run and vice versa over a network. The network is assumed to comprise a portion of a global computer network such as the Internet, although other types of networks can be part of the network, including a wide area network (WAN), a local area network (LAN), a satellite network, a telephone or cable network, a cellular network, a wireless network such as a WiFi or WiMAX network, or various portions or combinations of these and other types of networks. The network in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

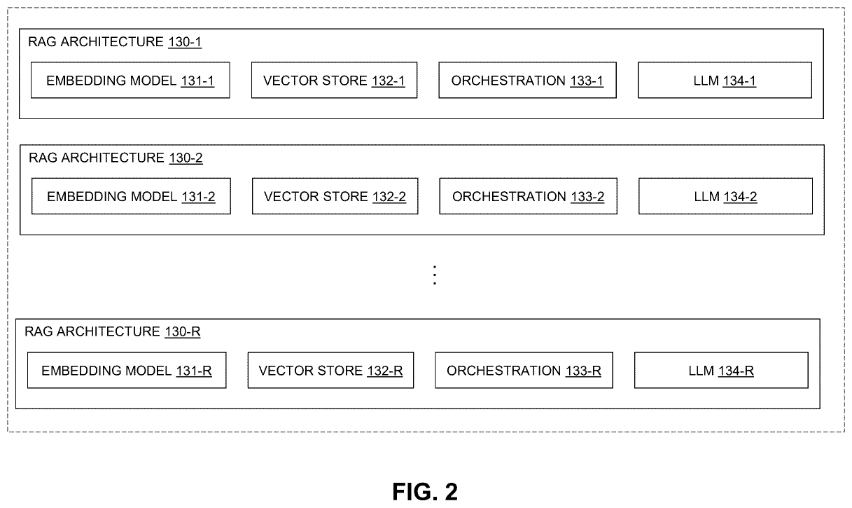

Referring to FIG. 1, the context recommendation platform 120 includes an LLM interface workflow engine 121, an LLM request caching engine 122, a store and LLM prediction engine 123 and a multi-vector store and LLM abstraction engine 124. Referring to FIG. 2, the RAG architectures 130-1, 130-2, . . . , 130-R respectively include embedding models 131-1, 131-2, . . . , 131-R (collectively “embedding models 131”), vector stores 132-1, 132-2, . . . , 132-R (collectively “vector stores 132”), orchestration layers 133-1, 133-2, . . . , 133-R (collectively “orchestration layers 133”) and LLMs 134-1, 134-2, . . . , 134-R (collectively “LLMs 134”).

The RAG architectures 130 leverage vector database and semantic search techniques to enhance the capabilities of the LLMs 134 with specific domain context. The RAG architectures 130 operate in a number of steps. For example, the embedding models 131 transform a query into an embedding, which is a high dimensional vector (e.g., number) representation. Each of the embedding models use a neural network encoder such as, for example, GPT3 DaVinci, Ada, BERT, etc. to perform the transformation. This encoding is required to convert the text into numbers while accurately capturing the semantic essence of the question, thus representing the query's intent, and meaning.

The RAG architectures 130 query the vector stores 132 (also referred to herein as vector databases) for domain context. In more detail, once a query is encoded, the resulting vector is used to perform a semantic search in a vector store 132 to return domain context pertinent to the question being asked. Each vector store 132 is pre-populated with pre-encoded vectors representing an array of domain specific information to find the relevant context for a given query. The semantic search leverages similarities in vector space, identifying database entries and/or records whose embeddings most closely align with that of the question.

The orchestration layers 133 build the LLM prompts. In more detail, with the relevant context for the question being retrieved, the next step involves integrating this retrieved information into a prompt for the LLM 134. This prompt includes the original query and the retrieved domain specific information to maintain logical and semantic continuity.

The orchestration layers 133 are used to call the LLMs 134. In more detail, a constructed prompt is fed to an LLM 134, which generates a response. Assuming the right combination of vector store(s) 132 and LLM 134, the response is relevant and accurate to the query in question, as it is a result of a prompt that has been enriched with domain specific knowledge.

As noted herein, a large enterprise may include multiple GenAI programs 103 and multiple RAG architectures 130. As can be understood from FIGS. 1 and 2, an enterprise will include multiple RAG architectures 130 with multiple embedding models 131, vector stores 132, orchestration layers 133 and LLMs 134.

In a RAG architecture 130, the accuracy and coherence of a response from an LLM 134 is dependent on the domain context being included as part of a prompt. As the LLMs 134 are pre-trained and lack domain specific knowledge, poor quality or insufficient domain context data can lead to hallucinations noted herein above. As most vector stores 132 operate differently from each other and the embedding models 131 use different neural network approaches, the type and amount of retrieved domain context information for the same question can vary significantly from one vector store 132 to another. Even if the LLM parameters between RAG architectures 130 remain the same, inconsistent context data for the same question from different vector stores 132 can cause poor responses and hallucinations.

The illustrative embodiments provide a universal platform that is able to interface with multiple GenAI programs 103 and multiple RAG architectures 130 to produce accurate query responses. For example, the universal platform addresses limitations where architectures require that queries use the same embedding model that was used by a vector store when the domain context data was embedded and stored in the vector store. Additionally, there may be scenarios where GenAI programs 103 may need to use context information from multiple vector stores 132 based on different technologies, and the embodiments can provide interface mechanisms to account for this situation. Similarly, the same question can be asked by multiple GenAI programs 103 (for example, both services and sales programs can ask a question about types of service offers available), but the context data can come from different sources (e.g., different vector stores 132). The illustrative embodiments provide the capability to dynamically identify what vector stores 132 are needed for a given question, and to make vector stores 132 visible to multiple GenAI programs 103 even if the vector store 132 is not coupled to a given GenAI program 103. The illustrative embodiments further provide mechanisms to account for the same questions being asked and not having to repeat processing when responses have already been generated.

In more detail, the context recommendation platform 120 predicts the optimum vector store(s) 132 and embedding model(s) 131 to retrieve the most appropriate context for a given question being asked by any GenAI program 103, predicts an LLM to provide a response and handles interfacing with the predicted vector stores 132 and predicted LLMs 134. Additionally, the context recommendation platform caches LLM responses so that questions that are asked repeatedly can be identified and their responses can be retrieved from the cache without going through the RAG process of embedding, semantic search of context and sending the prompt to an LLM for response.

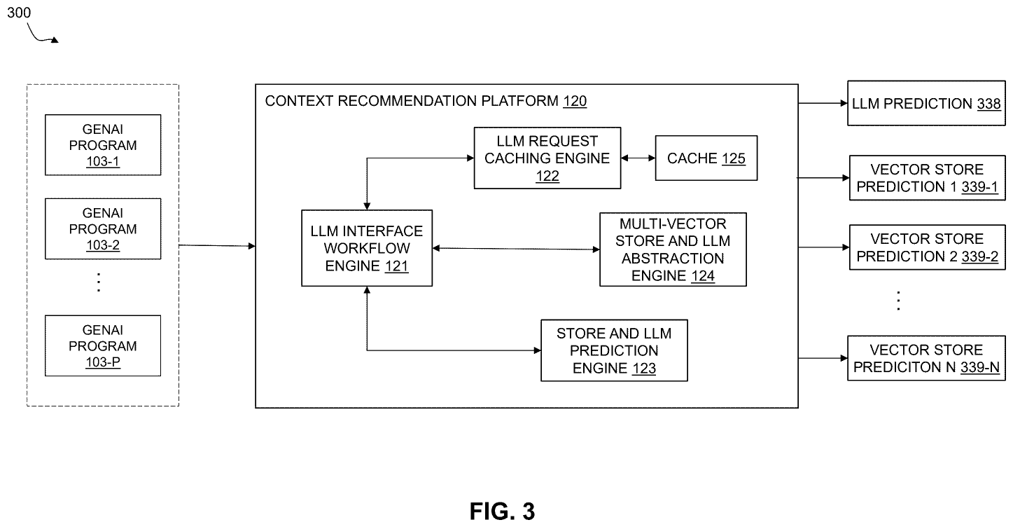

Referring to the information processing system 100 in FIG. 1, the RAG architectures 130 in FIG. 2 and the operational flow 300 for vector store and LLM prediction in FIG. 3, the context recommendation platform 120 performs caching of LLM requests received from GenAI programs 103 and caching of the corresponding responses to the LLM requests received from LLMs 134 of the RAG architectures 130. The context recommendation platform 120 also predicts the optimum vector store(s) 132 and LLM 134 to use in connection with generating the prompt for the request and responding to the request, and implements necessary interfaces (e.g., APIs) and commands to interface with the embedding models 131, vector stores 132, orchestration layers 133 and LLMs 134 of the RAG architectures.

All LLM requests from the GenAI programs 103 that use the RAG architectures 130 are passed through the LLM interface workflow engine 121, which generates a common word embedding vector of each request. The generation of the common word embedding is performed using, for example, term frequency-inverse document frequency (TF-IDF) techniques, latent semantic analysis (LSA) techniques or global vectors for word representation (GloVe) techniques or Word2Vec techniques. Once the vector is generated, the LLM request caching engine 122 performs a hashing function on the vector to generate a hash of the vector to be used as a unique identifier of the LLM request. The generated unique identifier may be stored in a cache 125 or other storage space if the unique identifier is not already present in the cache 125. The LLM request caching engine 122 queries the cache 125 to check if the unique identifier is in the cache 125, which would indicate that the LLM request was processed earlier. If the unique identifier is in the cache 125, the LLM request caching engine 122 retrieves a corresponding response to the earlier processed LLM request from the cache 125 and provides the response via a GenAI program 103 and a requesting device 102 to a requesting user. The LLM request caching engine 122 is configured to store and map unique identifiers of LLM requests and their corresponding responses in the cache 125.

If a unique identifier is not found in the cache 125, the LLM interface workflow engine 121 sends the request vector to the store and LLM prediction engine 123, which uses one or more machine learning algorithms to analyze the request vector and predicts (i) an LLM 134 to process and to respond to the LLM request; and (ii) one or more vector stores 132 from which data is to be used to generate a prompt for the LLM 134. For example, as can be seen in FIG. 3, the context recommendation platform 120 outputs an LLM prediction 338 and one or more vector store predictions (e.g., vector store prediction 1 339-1, vector store prediction 2 339-2, . . . , vector store prediction N 339-N (collectively “vector store predictions 339”)).

The LLM prediction 338 and vector store predictions 339 are input to the multi-vector store and LLM abstraction engine 124 via the LLM interface workflow engine 121. The multi-vector store and LLM abstraction engine 124 interfaces with the predicted LLM 134 and at least one vector store 132 to enable the LLM 134 to process and to respond to the LLM request. In more detail, multi-vector store and LLM abstraction engine 124 creates the appropriate embedding API calls, vector-based semantic search API calls, prompt creation API calls and LLM API calls for the RAG architecture(s) 130 corresponding to the predicted LLM 134 and vector store(s) 132 so that the prompt for the LLM 134 and LLM response can be generated. The LLM response is cached by the LLM request caching engine 122 with the corresponding hash value of the request vector as the unique identifier for future transactions where the same LLM request may be received.

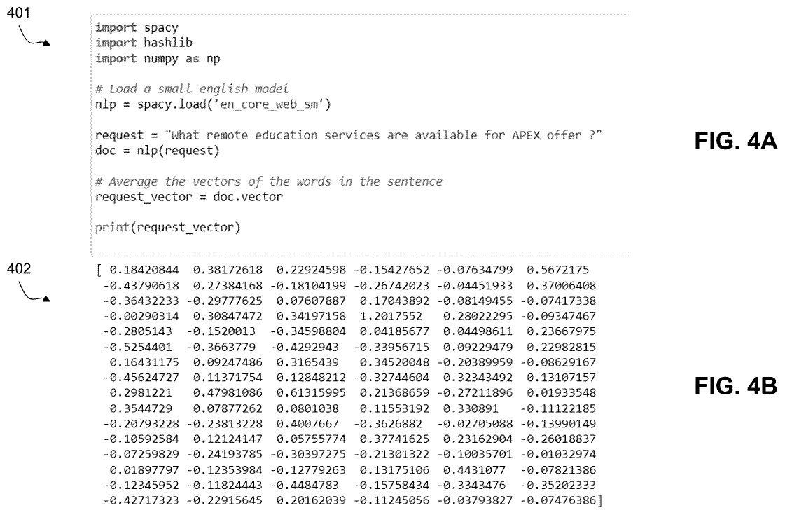

In connection with creating the request vector, in illustrative embodiments, the LLM interface workflow engine 121 uses Spacy, which is a sophisticated NLP library, to generate the vector for a request sentence. The vectorization, in connection with hashing, creates an identifier of the LLM request and the resulting vector is used as a feature in the store and LLM prediction engine 123 when predicting the most appropriate vector store(s) 132 and LLM 134. FIG. 4A depicts example pseudocode 401 for generating a vector of a request sentence, which states: “What remote education services are available for APEX offer?”. The pseudocode 401 in this case is Python code. FIG. 4B depicts the resulting vector 402 of the request sentence.

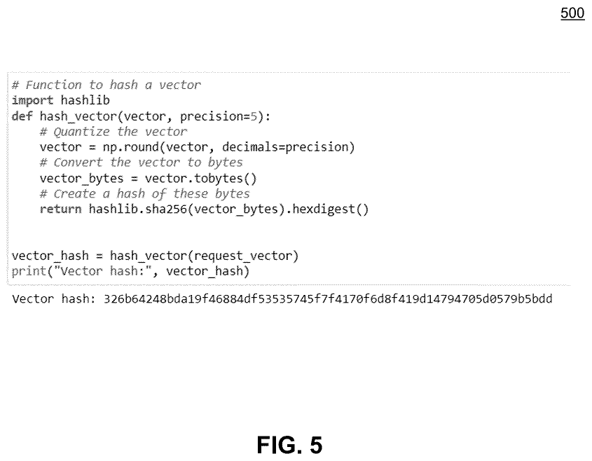

The LLM request caching engine 122 caches an identifier of an LLM request from a GenAI program 103 and a corresponding response to the LLM request from the predicted LLM 134. After generating a vector of the request, using a hash function, the LLM request caching engine 122 hashes the request to create the unique identifier, which is used in connection with querying to check if the same request was processed earlier. If the unique identifier is found in the cache 125, its corresponding response can be retrieved from the cache 125 and returned to a requesting user, thus eliminating the need to predict the vector store 132 and LLM 134, and to complete RAG processing to generate the prompt and a response to the request. As a result, performance is improved and, in case of commercial LLMs and embedding models, licensing costs can be reduced. FIG. 5 depicts example pseudocode 500 (e.g., Python code) for generating a hash from a request vector and the resulting vector hash. As can be understood from the pseudocode 500, the vector is quantized, converted to bytes and the hash is created using a sha-256 hash function.

The store and LLM prediction engine 123 predicts the most appropriate vector store(s) 132 and LLM 134 for a given LLM request. In illustrative embodiments, the store and LLM prediction engine 123 uses a sophisticated, discriminative artificial intelligence (AI)-based machine learning algorithm to build a multi-target model for predicting the vector store(s) 132 and the LLM 134. In illustrative embodiments, the machine learning algorithm comprises a deep neural network configured to predict a plurality of targets. The plurality of targets comprise the LLM 134 and one or more vector stores 132. The neural network includes a plurality of parallel networks respectively corresponding to the plurality of targets. In illustrative embodiments, a first parallel network of the plurality of parallel networks corresponding to the LLM 134 comprises a multi-class classifier and a second parallel network of the plurality of parallel networks corresponding to the one or more vector stores 132 comprises a multi-label classifier. Considering many requests involve context information that can span across multiple vector stores, a multi-label classifier where multiple values are predicted, is used for predicting one or more vector stores 132 and multi-class classifier, where a single value out of multiple possible values is predicted, is used for predicting the LLM 134.

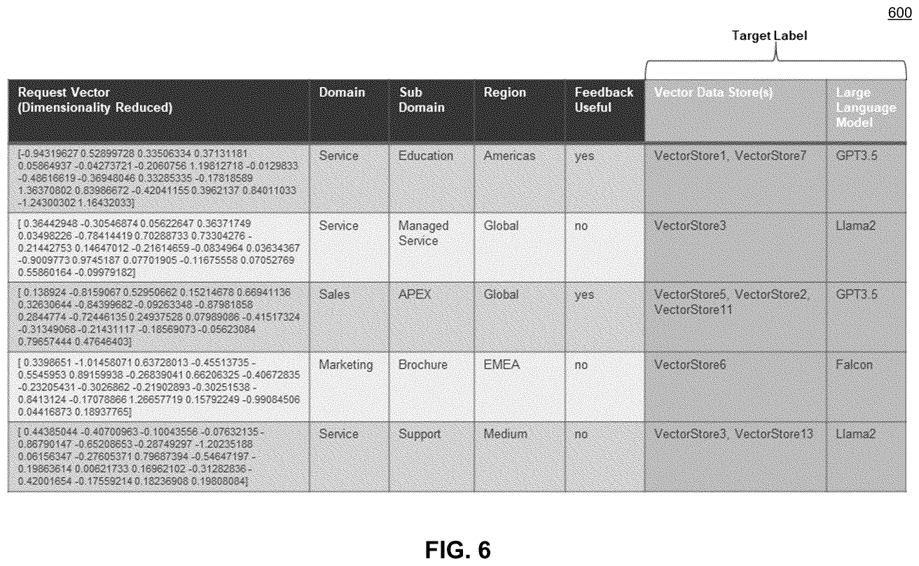

The machine learning algorithm is trained with historical data corresponding to a plurality of large language model requests. As can be seen in the table 600 in FIG. 6, the historical data specifies for respective ones of the plurality of LLM requests: (i) a request vector (where the dimensionality of the vector has been reduced using, for example, PCA); (ii) a domain (e.g., business domain such as, for example, “service,” “sales,” “marketing,” etc.); (iii) a sub-domain (e.g., “education,” “managed service,” “APEX,” “brochure,” “support,” etc.); (iv) geographic region (e.g., “Americas,” “global,” “Europe, Middle East, and Africa (EMEA),” “medium,” etc.); (v) usefulness of a response to a corresponding request (“yes” or “no”, usefulness value (e.g., efficiency score, ranking or other metric)). The training data further includes target values for respective ones of the plurality of LLM requests including vector store(s) (or other database(s)) used in connection with generating an LLM prompt and an LLM used to generate the response to the corresponding request. Other features can be added based on, for example, the segregation criteria of vector stores (e.g., a platform like SalesForce or ServiceNow).

In illustrative embodiments, following generation of an LLM response, feedback data regarding the quality of a response to the LLM request is collected and training of the machine learning algorithm is updated based on the collected feedback data. The collected data can include a ranking or score of the response.

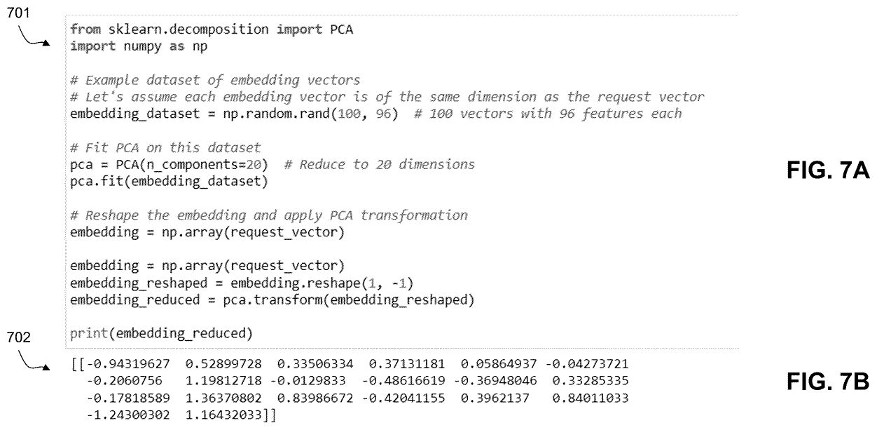

Request vectors after embedding may have high dimensionality. Accordingly, illustrative embodiments use PCA to generate a vector of smaller dimension, which is used in the training data, and as data inputted to the machine learning model when predicting vector store(s) and an LLM. Pseudocode 701 for common embedding of an LLM request and PCA to reduce dimensionality of the request vector is shown in FIG. 7A. FIG. 7B depicts the request vector 702 with reduced dimensionality.

The machine learning algorithm comprises a deep neural network based multi-target classifier that has one input layer, two parallel networks of hidden layers and an output layer. The two parallel networks use the same input layer and input data and predict different target values (vector store(s) s 132 and LLM 134). The network that predicts vector store(s) 132 is a multi-label classifier with an output layer including a number of neurons equal to the number of vector stores (in a non-limiting illustrative example, 14 vector stores). The network that predicts LLM 134 is a multi-class classifier with an output layer including a number of neurons matching the number of LLMs 134. In a non-limiting illustrative example, 3 neurons corresponding to a GPT3.5 LLM, Llama2 LLM and a Falcon LLM.

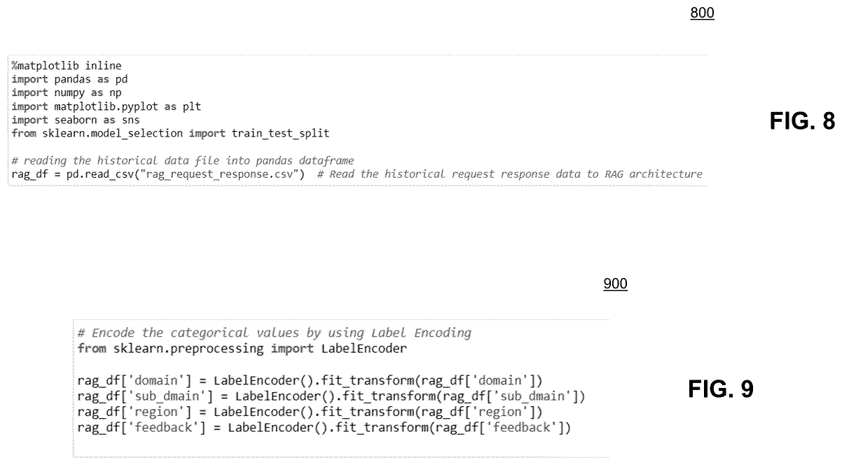

FIG. 8 depicts example pseudocode 800 for importation of libraries and for loading historical request response data into a data frame. For example, Tensorflow®, Keras, Python, ScikitLearn, Pandas and/or Numpy libraries can be used. The historical request response data is loaded into a Pandas data frame for building the training data. The data may be in the form of a CSV file. Since machine learning works with vectors (e.g., numbers), categorical and textual attributes like domain, sub-domain, region, whether the request is useful, etc. must be encoded before being used as training data. In one or more embodiments, this can be achieved by leveraging a LabelEncoder function of ScikitLearn library as shown in the pseudocode 900 in FIG. 9.

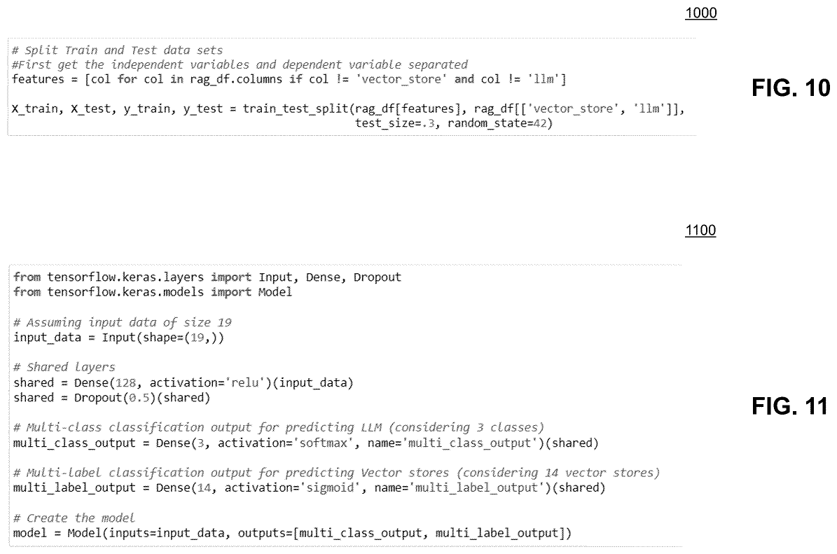

According to illustrative embodiments, the encoded training dataset is split into training and testing datasets, and separate datasets are created for independent variables and dependent variables. FIG. 10 depicts example pseudocode 1000 for splitting a dataset into training and testing components and for creating separate datasets for independent (X) and dependent (y) variables. The dataset is split into training and testing datasets using train_test_split function of ScikitLearn library with, for example, a 70%-30% split.

Once the datasets are ready for training and testing, the multi-target neural network is created by using Tensorflow® and Keras model functions. FIG. 11 depicts example pseudocode 1100 for using the designated model functions to build the neural network. With reference to the pseudocode 1100, a single input layer with, for example, 19 neurons for input data and a shared layer of 128 neurons is created with a rectified linear unit (ReLu) activation function. Two separate output layers are created (multi-class for predicting LLM and multi-label for predicting vector stores) with softmax and sigmoid activation functions, respectively.

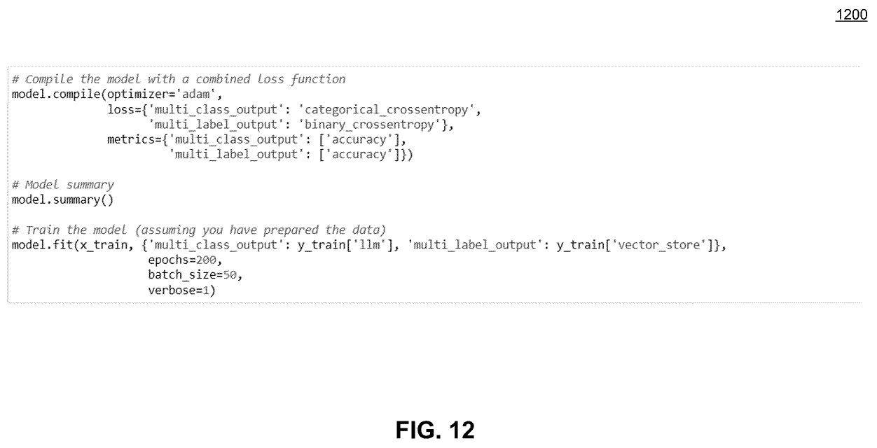

FIG. 12 depicts example pseudocode 1200 for assembling a neural network, setting a loss function, metrics and an optimizer of a neural network, and training the model. The model is compiled with using “adam” as the optimizer, and categorical_crossentropy and binary_crossentropy as the loss functions for the two networks, respectively. Accuracy is used as a metric for both networks. The model is trained by calling a fit( ) function of the model and passing training data through the neural network for a designated number of epochs. After the model completes a designated number of epochs, the model is trained and ready for prediction, which can be achieved by calling the predict( ) function of the model and passing the reduced vector of the request through the neural network.

In connection with a given LLM request, the multi-vector store and LLM abstraction engine 124 interfaces with various vector stores 132 for semantic search of contextual data for the request that is used in connection with generating the LLM prompt. In addition, the multi-vector store and LLM abstraction engine 124 interfaces with a predicted LLM 134 for generating the response. As explained herein above, the LLM prompt is generated from a combination of the contextual data and the LLM request. The multi-vector store and LLM abstraction engine 124 uses appropriate API calls for embedding the request and querying the predicted vector stores 132 to retrieve context of the request. Based on the predicted LLM 134, the multi-vector store and LLM abstraction engine 124 uses APIs and credentials for the LLM 134 to send the prompt and receive the response.

The multi-vector store and LLM abstraction engine 124 further leverages automated and manual approaches to collect feedback data regarding the usefulness of the LLM response when the combination of the predicted vector stores 132 and LLM 134 are used. As an automated process, the multi-vector store and LLM abstraction engine 124 uses BLEU (bilingual evaluation understudy), ROGUE (recall oriented understudy for Gisting Evaluation) and/or METEOR (metric for evaluation of translation with explicit ordering) metrics to compute the accuracy and coherence of the generated response from the LLM 134 based on the inputted prompt including the retrieved contextual data. With high value metrics, the response is deemed useful, and the usefulness is recorded for use in the updated training of the machine learning algorithm used by the store and LLM prediction engine 123. As a manual step, users can identify the usefulness of the LLM response, which can be inputted to the machine learning algorithm and used as training data.

In some embodiments, the cache 125 and other data corpuses, repositories or databases referred to herein are implemented using one or more storage systems or devices associated with the context recommendation platform 120. In some embodiments, one or more of the storage systems utilized to implement the cache 125 and other data corpuses, repositories or databases referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the context recommendation platform 120, the LLM interface workflow engine 121, LLM request caching engine 122, store and LLM prediction engine 123 and/or multi-vector store and LLM abstraction engine 124 in other embodiments can be implemented at least in part externally to the context recommendation platform 120, for example, as stand-alone servers, sets of servers or other types of systems coupled to the network. For example, the LLM interface workflow engine 121, LLM request caching engine 122, store and LLM prediction engine 123 and/or multi-vector store and LLM abstraction engine 124 may be provided as cloud services accessible by the context recommendation platform 120.

The LLM interface workflow engine 121, LLM request caching engine 122, store and LLM prediction engine 123 and/or multi-vector store and LLM abstraction engine 124 in the FIG. 1 embodiment are each assumed to be implemented using at least one processing device. Each such processing device generally comprises at least one processor and an associated memory, and implements one or more functional modules for controlling certain features of the LLM interface workflow engine 121, LLM request caching engine 122, store and LLM prediction engine 123 and/or multi-vector store and LLM abstraction engine 124.

At least portions of the context recommendation platform 120 and the elements thereof may be implemented at least in part in the form of software that is stored in memory and executed by a processor. The context recommendation platform 120 and the elements thereof comprise further hardware and software required for running the context recommendation platform 120, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the LLM interface workflow engine 121, LLM request caching engine 122, store and LLM prediction engine 123, multi-vector store and LLM abstraction engine 124 and other elements of the context recommendation platform 120 in the present embodiment are shown as part of the context recommendation platform 120, at least a portion of the LLM interface workflow engine 121, LLM request caching engine 122, store and LLM prediction engine 123, multi-vector store and LLM abstraction engine 124 and other elements of the context recommendation platform 120 in other embodiments may be implemented on one or more other processing platforms that are accessible to the context recommendation platform 120 over one or more networks. Such elements can each be implemented at least in part within another system element or at least in part utilizing one or more stand-alone elements coupled to the network.

It is assumed that the context recommendation platform 120 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or LXCs, or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the LLM interface workflow engine 121, LLM request caching engine 122, store and LLM prediction engine 123, multi-vector store and LLM abstraction engine 124 and other elements of the context recommendation platform 120, and the elements thereof can each be implemented in the form of one or more LXCs running on one or more VMs. Other arrangements of one or more processing devices of a processing platform can be used to implement the LLM interface workflow engine 121, LLM request caching engine 122, store and LLM prediction engine 123 and multi-vector store and LLM abstraction engine 124, as well as other elements of the context recommendation platform 120. Other portions of the system 100 can similarly be implemented using one or more processing devices of at least one processing platform.

Distributed implementations of the system 100 are possible, in which certain elements of the system reside in one data center in a first geographic location while other elements of the system reside in one or more other data centers in one or more other geographic locations that are potentially remote from the first geographic location. Thus, it is possible in some implementations of the system 100 for different portions of the context recommendation platform 120 to reside in different data centers. Numerous other distributed implementations of the context recommendation platform 120 are possible.

Accordingly, one or each of the LLM interface workflow engine 121, LLM request caching engine 122, store and LLM prediction engine 123, multi-vector store and LLM abstraction engine 124 and other elements of the context recommendation platform 120 can each be implemented in a distributed manner so as to comprise a plurality of distributed elements implemented on respective ones of a plurality of compute nodes of the context recommendation platform 120.

It is to be appreciated that these and other features of illustrative embodiments are presented by way of example only, and should not be construed as limiting in any way. Accordingly, different numbers, types and arrangements of system elements such as the LLM interface workflow engine 121, LLM request caching engine 122, store and LLM prediction engine 123, multi-vector store and LLM abstraction engine 124 and other elements of the context recommendation platform 120, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the context recommendation platform can be offered to cloud infrastructure customers or other users as part of FaaS, CaaS and/or PaaS offerings.

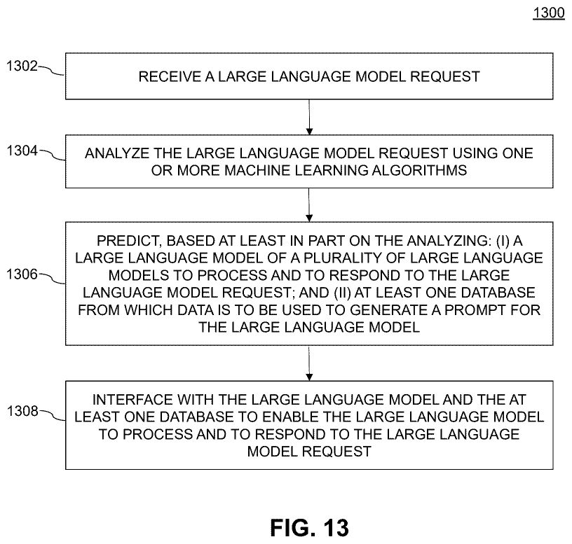

The operation of the information processing system 100 will now be described in further detail with reference to the flow diagram of FIG. 13. With reference to FIG. 13, a process 1300 for context recommendation as shown includes steps 1302 through 1308, and is suitable for use in the system 100 but is more generally applicable to other types of information processing systems comprising a context recommendation platform configured for predicting vector stores to use in connection with gathering contextual data for generating an LLM prompt and for predicting LLMs to process an LLM request.

In step 1302, an LLM request is received. In step 1304, the LLM request is analyzed using one or more machine learning algorithms. Step 1306 includes predicting, based at least in part on the analyzing: (i) a large language model of a plurality of large language models to process and to respond to the large language model request; and (ii) at least one database from which data is to be used to generate a prompt for the large language model. The at least one database may comprise a vector store.

In illustrative embodiments, the one or more machine learning algorithms comprise a neural network configured to predict a plurality of targets. The plurality of targets comprise the LLM and the at least one database, and the neural network includes a plurality of parallel networks respectively corresponding to the plurality of targets. A first parallel network of the plurality of parallel networks corresponding to the LLM comprises a multi-class classifier and a second parallel network of the plurality of parallel networks corresponding to the at least one database comprises a multi-label classifier.

Step 1308 includes interfacing with the large language model and the at least one database to enable the large language model to process and to respond to the large language model request. The interfacing may comprise generating one or more API calls to at least one of query the at least one database for the data to be used to generate the prompt, send the prompt to the LLM and receive a response to the LLM request.

The process may further include generating a vector of the LLM request, and executing a hash function on the vector to create a unique identifier for the LLM request. The process may also include receiving a response to the LLM request, and storing the response to the LLM request in correspondence with the unique identifier for the LLM request.

In illustrative embodiment, the process further comprises determining whether the LLM request matches a previous LLM request of a plurality of previous LLM requests. The steps of analyzing, predicting and interfacing are performed in response to determining that the LLM request differs from the plurality of previous LLM requests. Determining whether the LLM request matches the previous LLM request comprises creating a unique identifier for the LLM request, and comparing the unique identifier for the LLM request to a plurality of stored unique identifiers corresponding to respective ones of the plurality of previous LLM requests to determine whether the unique identifier for the LLM request matches a stored unique identifier of the plurality of stored unique identifiers.

In illustrative embodiments, the process further comprises receiving an additional LLM request, creating a unique identifier for the additional LLM request, and comparing the unique identifier for the additional LLM request to a plurality of stored unique identifiers corresponding to respective ones of a plurality of previous LLM requests to determine whether the unique identifier for the additional LLM request matches a stored unique identifier of the plurality of stored unique identifiers. A stored LLM response corresponding to the stored unique identifier is retrieved in response to determining that the unique identifier for the additional LLM request matches the stored unique identifier.

The one or more machine learning algorithms may be trained with historical data of a plurality of LLM requests. The historical data may specify for respective ones of the plurality of LLM requests at least one of: (i) a request vector; (ii) a domain; (iii) usefulness of a response to a corresponding request; (iv) a database used in connection with generating an LLM prompt; and (v) an LLM used to generate the response to the corresponding request.

In illustrative embodiments, feedback data regarding quality of a response to the LLM request is collected, and training of the one or more machine learning algorithms is updated based on the collected feedback data.

It is to be appreciated that the FIG. 13 process and other features and functionality described above can be adapted for use with other types of information systems configured to execute context recommendation services in a context recommendation platform or other type of platform.

The particular processing operations and other system functionality described in conjunction with the flow diagram of FIG. 13 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 13 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a context recommendation platform as disclosed herein can provide a number of significant advantages relative to conventional arrangements. For example, the context recommendation platform advantageously utilizes predictive intelligence for context store and LLM selection for specific queries. The predictive intelligence is based on sophisticated machine learning techniques that make use of deep neural networks that are trained with historical data corresponding to previous LLM requests, context stores that were used to generate LLM prompts and LLMs that were used to respond to the previous requests, as well as the usefulness of the context stores and the LLMs.

The embodiments advantageously leverage NLP and deep neural network-based classifiers to predict the appropriate context stores and LLMs. The deep neural network-based classifiers are automatically updated based on automatically computed and/or manual feedback including efficiency values for the predicted context stores and LLMs.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the context recommendation platform 120 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a context recommendation platform in illustrative embodiments. These and other cloud-based systems in illustrative embodiments can include object stores.

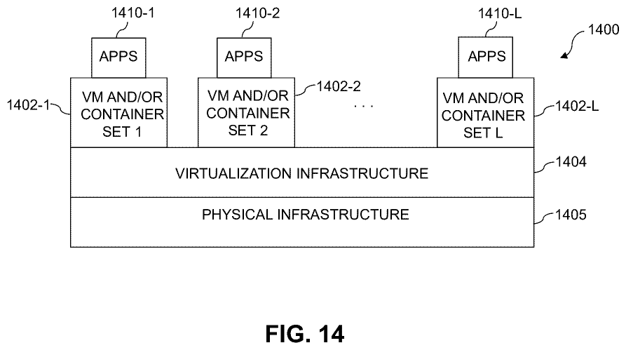

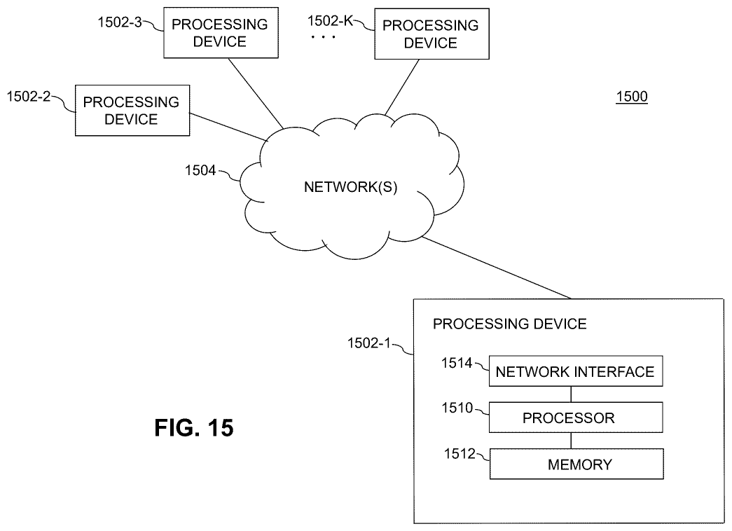

Illustrative embodiments of processing platforms will now be described in greater detail with reference to FIGS. 14 and 15. Although described in the context of system 100, these platforms may also be used to implement at least portions of other information processing systems in other embodiments.

FIG. 14 shows an example processing platform comprising cloud infrastructure 1400. The cloud infrastructure 1400 comprises a combination of physical and virtual processing resources that may be utilized to implement at least a portion of the information processing system 100. The cloud infrastructure 1400 comprises multiple virtual machines (VMs) and/or container sets 1402-1, 1402-2, . . . 1402-L implemented using virtualization infrastructure 1404. The virtualization infrastructure 1404 runs on physical infrastructure 1405, and illustratively comprises one or more hypervisors and/or operating system level virtualization infrastructure. The operating system level virtualization infrastructure illustratively comprises kernel control groups of a Linux operating system or other type of operating system.

The cloud infrastructure 1400 further comprises sets of applications 1410-1, 1410-2, . . . 1410-L running on respective ones of the VMs/container sets 1402-1, 1402-2, . . . 1402-L under the control of the virtualization infrastructure 1404. The VMs/container sets 1402 may comprise respective VMs, respective sets of one or more containers, or respective sets of one or more containers running in VMs.

In some implementations of the FIG. 14 embodiment, the VMs/container sets 1402 comprise respective VMs implemented using virtualization infrastructure 1404 that comprises at least one hypervisor. A hypervisor platform may be used to implement a hypervisor within the virtualization infrastructure 1404, where the hypervisor platform has an associated virtual infrastructure management system. The underlying physical machines may comprise one or more distributed processing platforms that include one or more storage systems.

In other implementations of the FIG. 14 embodiment, the VMs/container sets 1402 comprise respective containers implemented using virtualization infrastructure 1404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1400 shown in FIG. 14 may represent at least a portion of one processing platform. Another example of such a processing platform is processing platform 1500 shown in FIG. 15.

The processing platform 1500 in this embodiment comprises a portion of system 100 and includes a plurality of processing devices, denoted 1502-1, 1502-2, 1502-3, . . . 1502-K, which communicate with one another over a network 1504.

The network 1504 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1502-1 in the processing platform 1500 comprises a processor 1510 coupled to a memory 1512. The processor 1510 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1512 may comprise random access memory (RAM), read-only memory (ROM), flash memory or other types of memory, in any combination. The memory 1512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1502-1 is network interface circuitry 1514, which is used to interface the processing device with the network 1504 and other system components, and may comprise conventional transceivers.

The other processing devices 1502 of the processing platform 1500 are assumed to be configured in a manner similar to that shown for processing device 1502-1 in the figure.

Again, the particular processing platform 1500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the context recommendation platform 120 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and context recommendation platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving a large language model request;
analyzing the large language model request using one or more machine learning algorithms;
predicting, based at least in part on the analyzing: (i) a large language model of a plurality of large language models to process and to respond to the large language model request; and (ii) at least one database from which data is to be used to generate a prompt for the large language model; and
interfacing with the large language model and the at least one database to enable the large language model to process and to respond to the large language model request;
wherein the steps of the method are executed by a processing device operatively coupled to a memory.

2. The method of claim 1 further comprising generating a vector of the large language model request.

3. The method of claim 2 further comprising executing a hash function on the vector to create a unique identifier for the large language model request.

4. The method of claim 3 further comprising:
receiving a response to the large language model request; and
storing the response to the large language model request in correspondence with the unique identifier for the large language model request.

5. The method of claim 1 further comprising:
determining whether the large language model request matches a previous large language model request of a plurality of previous large language model requests; and
performing the analyzing, predicting and interfacing in response to determining that the large language model request differs from the plurality of previous large language model requests.

6. The method of claim 5 wherein determining whether the large language model request matches the previous large language model request comprises:
creating a unique identifier for the large language model request; and
comparing the unique identifier for the large language model request to a plurality of stored unique identifiers corresponding to respective ones of the plurality of previous large language model requests to determine whether the unique identifier for the large language model request matches a stored unique identifier of the plurality of stored unique identifiers.

7. The method of claim 1 further comprising:
receiving an additional large language model request;
creating a unique identifier for the additional large language model request;
comparing the unique identifier for the additional large language model request to a plurality of stored unique identifiers corresponding to respective ones of a plurality of previous large language model requests to determine whether the unique identifier for the additional large language model request matches a stored unique identifier of the plurality of stored unique identifiers.

8. The method of claim 7 further comprising retrieving a stored large language model response corresponding to the stored unique identifier in response to determining that the unique identifier for the additional large language model request matches the stored unique identifier.

9. The method of claim 1 wherein:
the one or more machine learning algorithms comprise a neural network configured to predict a plurality of targets;
the plurality of targets comprise the large language model and the at least one database; and
the neural network includes a plurality of parallel networks respectively corresponding to the plurality of targets.

10. The method of claim 9 wherein a first parallel network of the plurality of parallel networks corresponding to the large language model comprises a multi-class classifier and a second parallel network of the plurality of parallel networks corresponding to the at least one database comprises a multi-label classifier.

11. The method of claim 1 wherein the one or more machine learning algorithms are trained with historical data of a plurality of large language model requests.

12. The method of claim 11 wherein the historical data specifies for respective ones of the plurality of large language model requests at least one of: (i) a request vector; (ii) a domain; (iii) usefulness of a response to a corresponding request; (iv) a database used in connection with generating a large language model prompt; and (v) a large language model used to generate the response to the corresponding request.

13. The method of claim 11 further comprising:
collecting feedback data regarding quality of a response to the large language model request; and
updating training of the one or more machine learning algorithms based on the collected feedback data.

14. The method of claim 1 wherein the at least one database comprises a vector store.

15. The method of claim 1 wherein the interfacing comprises generating one or more application programming interface calls to at least one of query the at least one database for the data to be used to generate the prompt, send the prompt to the large language model and receive a response to the large language model request.

16. An apparatus comprising:
a processing device operatively coupled to a memory and configured:
to receive a large language model request;
to analyze the large language model request using one or more machine learning algorithms;
to predict, based at least in part on the analyzing: (i) a large language model of a plurality of large language models to process and to respond to the large language model request; and (ii) at least one database from which data is to be used to generate a prompt for the large language model; and
to interface with the large language model and the at least one database to enable the large language model to process and to respond to the large language model request.

17. The apparatus of claim 16 wherein the processing device is further configured:
to determine whether the large language model request matches a previous large language model request of a plurality of previous large language model requests; and
to perform the analyzing, predicting and interfacing in response to determining that the large language model request differs from the plurality of previous large language model requests.

18. The apparatus of claim 17 wherein, in determining whether the large language model request matches the previous large language model request, the processing device is configured:
to creating a unique identifier for the large language model request; and
to compare the unique identifier for the large language model request to a plurality of stored unique identifiers corresponding to respective ones of the plurality of previous large language model requests to determine whether the unique identifier for the large language model request matches a stored unique identifier of the plurality of stored unique identifiers.

19. An article of manufacture comprising a non-transitory processor-readable storage medium having stored therein program code of one or more software programs, wherein the program code when executed by at least one processing device causes said at least one processing device to perform the steps of:
receiving a large language model request;
analyzing the large language model request using one or more machine learning algorithms;
predicting, based at least in part on the analyzing: (i) a large language model of a plurality of large language models to process and to respond to the large language model request; and (ii) at least one database from which data is to be used to generate a prompt for the large language model; and
interfacing with the large language model and the at least one database to enable the large language model to process and to respond to the large language model request.

20. The article of manufacture of claim 19 wherein the program code further causes said at least one processing device to perform the steps of:
determining whether the large language model request matches a previous large language model request of a plurality of previous large language model requests; and
performing the analyzing, predicting and interfacing in response to determining that the large language model request differs from the plurality of previous large language model requests.
